(19) United States
(12) Patent Application Publication
(10) Pub. No.: US 2007/0168525 A1
(43) Pub. Date: Jul. 19, 2007

(54) Method for improved virtual adapter performance using multiple virtual interrupts

(76) Inventors: Baltazar DeLeon III, Austin, TX (US); Herman Dietrich Dierks JR., Round Rock, TX (US); Kiet H. Lam, Round Rock, TX (US)

Correspondence Address: IBM CORP (YA);C/O YEE & ASSOCIATES PC, P.O. BOX 802333, DALLAS, TX, 75380, US

(21) Appl. No.: 11/334,660

(22) Filed: Jan. 18, 2006

(51) Int. Cl. G06F 15/16

(52) U.S. Cl. 709/228

(57) ABSTRACT

The present invention provides a computer implemented method, apparatus, and computer usable program code for processing multiple interrupts for multiple packets concurrently. First, data packets are assigned one of a set of interrupt queues for a virtual adapter in response to detecting the data packets. Each of the interrupt queues is processed by one of a set of interrupt threads for executing an interrupt handler. Next, an interrupt is dispatched for each of the interrupt queues receiving the data packets. The data packets in the interrupt queues are concurrently processed by one of the set of interrupt threads.

### BACKGROUND OF THE INVENTION

1. Field of the Invention

The present invention relates generally to an improved data processing system and in particular, to a computer implemented method, apparatus, and computer usable program code for improving virtual adapter performance.

2. Description of the Related Art

Multi-processing and advanced capabilities of modern computing devices have lead to the proliferation of virtual devices. A virtual device appears as one physical device, even though its capabilities are derived from one or more physical computing devices. The virtual device functions as an autonomous device even though this device is implemented in a software interface layer. The virtual device shares the resources of the host computing devices to process and store information. Virtual devices mimic actual physical devices and include disks, serial ports, and Ethernet adapters.

A virtual Ethernet adapter allows virtual machines and partitions to communicate using standard Ethernet protocols. A partition is a logical section or division of a physical computing device. Each division or partition functions as if it is a physically separate unit and is dedicated to a particular operating system or application. In one example, different partitions of a single server may communicate with one another through virtual Ethernet adapters. Virtual Ethernet adapters' implementation has traditionally used a single interrupt. A single interrupt limits the virtual Ethernet adapter performance to the processing cycles of a single central processing unit (CPU) when receiving data even when there are multiple processing units available on the computing system. This processing limitation is present because the virtual Ethernet adapter registered only one interrupt for the interrupt handler to dispatch.

Attempts have been to address the interrupt processing problem by queuing receive packets early on in and notifying the operating system kernel of queued packets. The interrupt thread can then go back to check for more packets and append them to the queue. The operating system kernel uses one or more kernel threads to process the packets in the queue. The processing normally performed by the interrupt thread is offloaded to other kernel threads, which can run in parallel on other central processing units increasing the processing cycles available to process incoming packets. Because most of the lengthy processing is offloaded to the kernel threads, the interrupt thread only needs to execute the shorter path of extracting the packets off the receive queue and pass the packets to the off-load threads. As a result, more packets may be received by the virtual Ethernet adapter.

A lock is used to access the queue as the interrupt thread and the kernel off-load threads all try to access the queue concurrently. The interrupt thread adds packets to the queue while the off-load threads remove them from the queue. The lock is needed to keep the queue coherent. The contention on the lock becomes hot as the number of kernel off-load threads increases and the packet arrival rate increases. The system consumes processor cycles waiting for access to the queue instead of doing useful work. As a result, the performance of the virtual Ethernet adapter is prevented from scaling up as the packet arrival rate increases.

First, as the packets are first queued, additional extraneous processing cycles are incurred. Secondly, there are additional processing cycles consumed by the kernel off-load threads extracting the packets off the queue to process them. Thirdly, when the packet arrival rate is not very high, the operating system must consume processing cycles to wake up the kernel off-load threads to perform the processing. All these extra processing cycles contributes to longer latency for the application to receive the data.

The number of kernel off-load threads are determined at design time or during the boot up process. Kernel threads are designed to be shared among all components, such as other network adapters, in the system. When the packets from two network adapters, a virtual Ethernet adapter and a real Ethernet adapter, for example, happen to hash to the same queue serviced by a kernel off-load thread, throughput and latency can both degrade as the kernel thread now must split its time processing the packets from both network adapters.

### SUMMARY OF THE INVENTION

The present invention provides a computer implemented method, apparatus, and computer usable program code for processing multiple interrupts for multiple packets concurrently. First, data packets are assigned one of a set of interrupt queues for a virtual adapter in response to detecting the data packets. Each of the interrupt queues is processed by one of a set of interrupt threads for executing an interrupt handler. Next, an interrupt is dispatched for each of the interrupt queues receiving the data packets. The data packets in the interrupt queues are concurrently processed by one of the set of interrupt threads.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a diagram of a virtual machine in accordance with an illustrative embodiment of the present invention;

FIG. 4 is a flowchart illustrating the configuration of a virtual Ethernet adapter in accordance with an illustrative embodiment of the present invention; and

FIG. 5 is a flowchart illustrating packet routing in accordance with an illustrative embodiment of the present invention.

### DETAILED DESCRIPTION OF THE PREFERRED EMBODIMENT

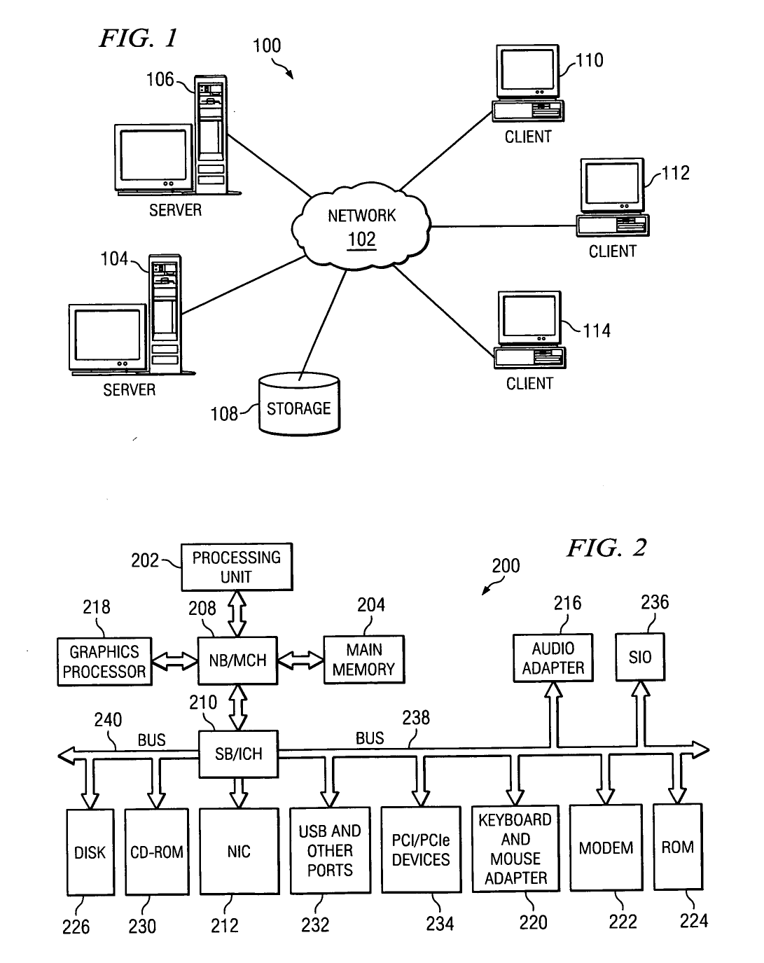

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

As a result of the increasing complexity of data processing systems and with the introduction of multimedia presentations, attempts have been made to simplify the interface between a user and the large amounts of data present within a modern data processing system. One example of an attempt to simplify the interface between a user and a data processing system is the utilization of a so-called graphic user interface (GUI) to provide an intuitive and graphical interface between a user and a computing device such as client 114.

A GUI is an interface system, including devices, by which a user interacts with a system, system components, and/or system applications via windows or view ports, icons, menus, pointing devices, electronic pens, touch screens, and other input devices. Information may be both input and viewed by the meeting planner and meeting invitees through the GUI.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, network interface card (NIC) 212 for accessing a local area network (LAN) connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, other Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as an Ethernet adapter, a modem 222 or NIC 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The different embodiments of the present invention provides a computer implemented method, apparatus, and computer usable program code for improving virtual adapter performance through using multiple virtual interrupts. A virtual driver and a hypervisor work together to improve the performance of the virtual adapter. In one illustrative embodiment, the virtual adapter is a virtual Ethernet adapter applicable to Ethernet data transmissions. Illustrative embodiments of the present invention are also applicable to other network types.

A hypervisor is herein defined as one form of a virtualization engine used to virtualize the computing device. A hypervisor is a scheme which allows multiple operating systems to run on a host computer at the same time in order to extract as much work as possible from a single system including one or more processors. For example, virtual machine 1 running operating system A can be stored and run on partition 1 and virtual machine 2 running operating system B can be stored and run on partition 2 at any given time. The hypervisor presents different virtualized hardware views to each of the operating systems. The virtualized hardware views are normally called partition. These partitions are defined with different hardware resources by the users to fit their computing needs.

A receive or interrupt queue is associated with each interrupt. The number of receive queues registered with the system is a function of the peripheral devices, such as Ethernet adapter, multifunction devices, and the device driver. The number of receive queues is not tied to the number of processors assigned to each partition even though no performance gain is expected by having more receive queues than processors.

When a packet is destined to the virtual Ethernet adapter, the hypervisor delivers the packet to one of the receive queue and sets the corresponding interrupt. Multiple receive queues allows multiple interrupt threads to be active at the same time when many packets from a number of transport control protocol (TCP) or user datagram protocol (UDP), or Internet Protocol (IP) based protocol in general, are received by the virtual Ethernet adapter. Higher performance is achieved as each interrupt thread allows the received packets to be processed by different processors.

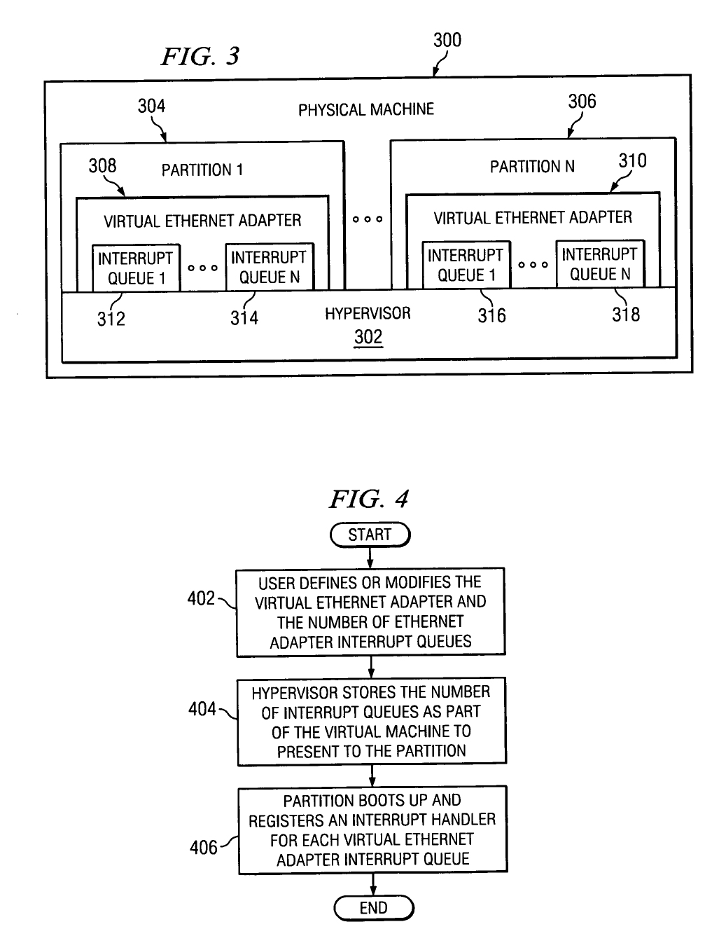

FIG. 3 is a diagram of a virtual machine in accordance with an illustrative embodiment of the present invention. Each virtual device is implemented on physical machine 300. Physical machine 300 is a data processing system such as server 104 of FIG. 1 or data processing system 200 of FIG. 2. Hypervisor 302 is a virtualization engine used to virtualize physical machine 300 and sits at the bottom layer. Hypervisor 302 presents virtualized machines to the partitions and facilitates input and output activities.

Physical machine 300 defines partition 1 304 and partition N 306. A partition is a logical section or division of a computing resource. Each division or partition functions as if it is a physically separate unit and is dedicated to a particular operating system or application. In this illustrative embodiment, partition 1 304 is running operating system A, while partition N 306 is running operating system B. Physical machine 300 may be divided into many more partitions than are shown in the present illustrative embodiment. For example, physical machine 300 may define four partitions each running a separate operating system using the processor or processors and hardware peripherals of physical machine 300. Each operating system needs a device driver to use the virtual Ethernet adapter just as a device driver is required for a physical device.

Partition 1 304 contains virtual Ethernet adapter 308 and partition N 306 contains virtual Ethernet adapter 310. In another embodiment, partition 1 304 and partition N 306 may define any number of virtual Ethernet adapters. Virtual Ethernet adapters 308, 310 are not hardware entities. The user instructs hypervisor 302 whether virtual Ethernet adapters 308, 310 are to be presented to a particular partition and what attributes virtual Ethernet adapters 308, 310 have. The user may also specify virtual Ethernet adapter attributes such as the number of interrupt queues for virtual Ethernet adapters 308, 310. Virtual Ethernet adapters 308 and 310 define any number of interrupt queues.

An interrupt queue is storage in memory for processing packets received. A packet cannot be processed by the operating system until an available processor is interrupted and instructed to execute the appropriate interrupt handler or interrupt handler routine to process the packets on the interrupt queue. Packets are assigned to different interrupt queue bases on a hashing algorithm to keep related packets together and in the order they are received. The use of multiple interrupt queues in conjunction with multiple interrupt threads for processing of received packets on multiple processors is unique because it allows more data to be processed in a much shorter time period. A set of interrupt threads as refers to one or more interrupt threads.

In the present illustrative embodiment, virtual Ethernet adapter 308 defines interrupt queue 1 312 and interrupt queue N 314 as attributes and virtual Ethernet adapter 310 defines interrupt queue 1 316 and interrupt queue N 318 as attributes. The given illustrative example is novel because traditional virtual Ethernet adapters have only a single interrupt queue. Virtual Ethernet adapters 308 and 310 define and register the interrupt queues at virtual Ethernet adapter creation time among other attributes.

An exemplary communication between the virtual elements of physical machine 300 is provided for purposes of illustration. When partition 1 304 seeks to send a packet to partition N 306, Virtual Ethernet adapter 308, the sending virtual Ethernet adapter, makes a service call to hypervisor 302 to send the data. Hypervisor 302 routes the packet to virtual Ethernet adapter 310, the receiving virtual Ethernet adapter, based on the MAC address in the Ethernet frame header of the data packet. Because virtual Ethernet adapters 308 and 310 may include a number of interrupt queues, hypervisor 302 determines whether interrupt queue 1 316 or interrupt queue N 318 within virtual Ethernet adapter 310 should receive the packet.

Hypervisor 302 determines how packets should be hashed to the interrupt queues using any number of hashing strategies or algorithms. Hashing is defined herein as allocating, assigning, or sorting data algorithmically to distribute packets across the interrupt queues while keeping related packets together and maintaining the order in which the packets are received. Implementations of hashing may be based on source or destination Internet protocol (IP) address, source port number, destination port number, or any combination thereof. For example, hashing may call for packet sent from IP address 216.157.135.128 with source port number 67 to be hashed to interrupt queue 1 316.

Once virtual Ethernet adapter 310 is designated as the receiving virtual Ethernet adapter and the specified interrupt queue has been specified based on the hashing strategy, hypervisor 302 copies the data into the buffer of virtual Ethernet adapter 310. Once completed, hypervisor 302 generates an interrupt to notify virtual Ethernet adapter 310 of a new packet arrival. When multiple partitions or a single partition, such as partition 1 304 open multiple communication connections to the same partition, such as partition N 306, the hashing algorithm distributes the packets across the interrupt queues as the port numbers for each connections would be different, interrupt queue 1 316 and interrupt queue N 318 of virtual Ethernet adapter 310. The hashing strategy hashes the packets from the same connection to the same interrupt receive queue thus keeping packets in order and preventing packet retransmission from occurring. As a result, multiple interrupt threads run concurrently on multiple central processing units, drastically improving performance of virtual Ethernet adapter 310 in processing received packets.

Each of the interrupt queues is to be processed by an interrupt thread which executes the interrupt handler routine. Next, an interrupt, which executes the interrupt handler function registered by virtual Ethernet adapter 310 is dispatched for each of the interrupt queues receiving the data packets. The data packets in the interrupt queues are concurrently processed by the interrupt threads with each interrupt handler using one interrupt thread.

FIG. 4 is a flowchart illustrating the configuration of a virtual Ethernet adapter in accordance with an illustrative embodiment of the present invention. The processes illustrated in FIG. 4 may occur in a computing device such as physical machine 300 of FIG. 3, within interrupt queues such as interrupt queue 1 316 and interrupt queue N 318 of FIG. 3, a virtual Ethernet adapter such as virtual Ethernet adapter 310 of FIG. 3, a virtualization engine such as hypervisor 302 of FIG. 3, and a partition such as partition N 306 of FIG. 3. The process of FIG. 4 illustrates the steps of creating and defining the virtual Ethernet adapter in the virtual machine.

The process begins by receiving user input that defines or modifies the virtual Ethernet adapter and the number of Ethernet adapter interrupt queues (step 402). There are many attributes the user can modify. These attributes are implementation specific. The number of interrupt queues is a new attribute specifically for this invention. The number of interrupt queues is not tied to the number of central processing units available. However, there is normally no performance gain by having more interrupt queues than available central processing units. The user normally specifies the attributes of the virtual Ethernet adapter (step 402) by accessing a management console which may provide a graphical user interface to performance the task.

Next, the hypervisor stores the number of interrupt queues as part of the virtual machine to present to the partition (step 404). The partition boots up and registers an interrupt handler for each virtual Ethernet adapter interrupt queue (step 406) with the configuration process terminating thereafter. Registering an interrupt handler is operating system specific. The operating system has a set of application program interfaces for this purpose. An application program interface is an interface or calling convention by which an application program accesses the operating system and other services. Registering an interrupt handler involves telling the operating system which interrupt handler to involve when a specific interrupt occurs.

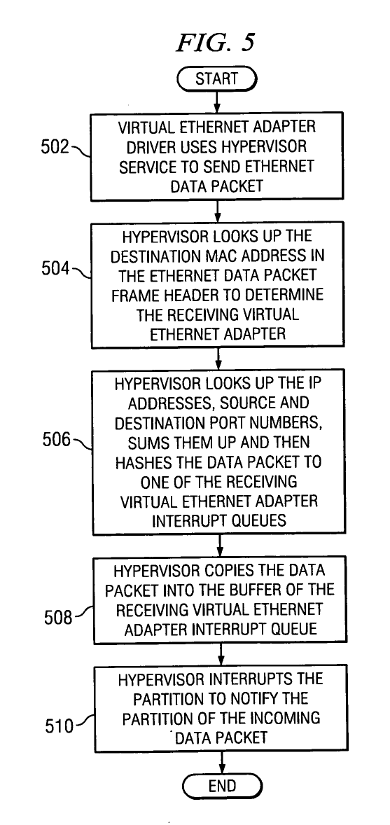

FIG. 5 is a flowchart illustrating packet routing in accordance with an illustrative embodiment of the present invention. The processes illustrated in FIG. 5 may occur in a computing device such as physical machine 300 of FIG. 3 and may be performed by a virtualization engine or partition firmware such as hypervisor 302 of FIG. 3, within a receiving virtual Ethernet adapter such as virtual Ethernet adapter 310 of FIG. 3, in an interrupt queue such as interrupt queue N 318 of FIG. 3, and a partition such as partition N 306 of FIG. 3.

The process begins with a virtual Ethernet adapter driver using the hypervisor service to send an Ethernet data packet (step 502). The hypervisor has a set of application program interfaces that the operating system can use to request service from it. These hypervisor services are a way to access the virtual hardware on the hypervisor. Virtual Ethernet adapter is an example of a virtual hardware on the hypervisor.

The hypervisor looks up the destination MAC address in the Ethernet packet frame header of the data packet to determine the receiving virtual Ethernet adapter (step 504). Next, the hypervisor looks up the IP addresses, source and destination port numbers, sums them up and then hashes the data packet to one of the receiving virtual Ethernet adapter interrupt queues (step 506). The hypervisor copies the data packet into the buffer of the receiving virtual Ethernet adapter interrupt queue (step 508). Finally, the hypervisor interrupts the partition to notify the partition of an incoming data packet (step 510) with the process terminating thereafter.

As numerous packets from different connections are received each packet is routed and hashed to different virtual Ethernet interrupt queue. The receipt of the packet sets an interrupt to notify the partition of the incoming data packet (step 510) so that a processor will process the packet. For example, four interrupt queues are registered to different interrupt handles so that the interrupt queues may be processed by four processors.

Illustrative embodiments of the present invention allow packets to be hashed to multiple virtual Ethernet adapter interrupt queues. The packets extracted from the interrupt queues are processed by multiple processors instead of a single processor. As a result, an individual processor is not overwhelmed with processing all the received packets, thus packet processing efficiency and productivity is increased.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters or network interface cards.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing multiple interrupts for multiple packets concurrently, the computer implemented method comprising:
responsive to detecting a plurality of data packets for a virtual adapter, assigning the plurality of data packets to a set of interrupt queues for the virtual adapter, wherein each of the set of interrupt queues is processed by one of a set of interrupt threads for executing an interrupt handler; and
dispatching an interrupt for each of the set of interrupt queues receiving the plurality of data packets, wherein the plurality of data packets in each of the set of interrupt queues is concurrently processed by each of the set of interrupt threads.

2. A computer implemented method of claim 1, further comprising:
modifying and creating at least one virtual adapter and the set of interrupt queues, wherein the at least one virtual adapter includes the virtual adapter;
storing the set of interrupt queues as part of a virtual machine to present to a partition; and
booting up and registering an interrupt handler for each interrupt queue in the set of interrupt queues, wherein each interrupt handler uses one of the set of interrupt threads.

3. The computer implemented method of claim 1, further comprising:
responsive to receiving the plurality of data packets, looking up a destination MAC address in a frame header of each of the plurality of data packets to determine the virtual adapter of a plurality of virtual adapters to receive each of the plurality of data packets;
hashing the each of the plurality of data packets to a receiving interrupt queue based on a hashing strategy;
copying each of the plurality of data packets into a buffer of the receiving interrupt queue; and
interrupting a partition to notify the partition that each of the plurality of data packets is incoming.

4. The computer implemented method of claim 3, wherein the steps are performed by a hypervisor.

5. The computer implemented method of claim 3, wherein the virtual adapter is a virtual Ethernet adapter.

6. The computer implemented method of claim 3, comprising sending the plurality of data packet from a first partition to the partition.

7. The computer implemented method of claim 3, wherein the looking up step is responsive to a first partition sending the plurality of data packets to the partition, wherein the first partition and the partition are on a single data processing system.

8. The computer implemented method of claim 2, wherein the modifying step comprises defining the at least one virtual adapter and the set of interrupt queues.

9. The computer implemented method of claim 8, wherein the modifying step is performed by a user.

10. The computer implemented method of claim 2, wherein the booting up and registering step is performed by the partition.

11. The computer implemented method of claim 2, wherein the set of interrupt thread allows the data packets to be processed by a set of processors.

12. The computer implemented method of claim 3, wherein the hashing strategy is based on at least one of a source IP address, destination IP address, source port number, and destination port number.

13. An apparatus comprising:
a set of processors for running at least one operating system;
a storage operably connected to the processor, wherein the storage defines a hypervisor, wherein the storage is divided into at least one partition that operates the at least one operating system, wherein the partition defines a virtual adapter, a set of interrupt queues, wherein the hypervisor sends a plurality of data packets to the set of interrupt queues in response to receiving the data packets for the virtual adapter, wherein the set of interrupt queues are processed by the set of processors, and wherein each of the set of interrupts queues dispatch an interrupt to a processor, wherein the plurality of data packets in the set of interrupt queues are concurrently processed for the virtual adapter.

14. The system of claim 13, wherein the hypervisor on the partition stores the at least one virtual adapter interrupt queue as part of a virtual machine to present to a partition, and wherein the partition boots up and registers an interrupt handler for the at least one of the virtual adapter interrupt queues.

15. The system of claim 13, wherein the hypervisor looks up a destination MAC address in a frame header of a data packet to determine a receiving virtual adapter from the a set of virtual adapters when the data packet is received, assigns the data packet to a receiving virtual adapter interrupt queue based on a hashing strategy, copies the data packet into a buffer of the receiving virtual adapter interrupt queue; and interrupts a partition to notify the partition that the data packet is incoming.

16. The system of claim 13, wherein a user defines at least one virtual adapter and at least one virtual adapter interrupt queue.

17. The system of claim 13, wherein the hypervisor is a virtualization engine.

18. A computer program product comprising a computer usable medium including computer usable program code processing multiple interrupts for multiple packets concurrently, said computer program product including:
computer usable program code responsive to detecting a plurality of data packets for a virtual adapter, for assigning the plurality of data packets to a set of interrupt queues for the virtual adapter, wherein each of the set of interrupt queues is processed by one of a set of interrupt threads for executing an interrupt handler; and
computer usable program code for dispatching an interrupt for each of the set of interrupt queues receiving the plurality of data packets, wherein the plurality of data packets in each of the set of interrupt queues is concurrently processed by each of the set of interrupt threads.

19. The computer program product of claim 18, further comprising:
computer usable program code for modifying at least one virtual adapter and the set of interrupt queues, wherein the at least one virtual adapter includes the virtual adapter;
computer usable program code for storing the set of interrupt queues as part of a virtual machine to present to a partition; and
computer usable program code for booting up and registering an interrupt handler for each interrupt queue in the set of interrupt queues, wherein each interrupt handler uses one of the set of interrupt threads.

20. The computer program product of claim 18, comprising:
computer usable program code responsive to receiving the plurality of data packets, for looking up a destination MAC address in a frame header of each of the plurality of data packets to determine the virtual adapter of a plurality of adapters to receive each of the plurality of data packets;
computer usable program code for assigning each of the plurality of data packets to a receiving interrupt queue based on a hashing strategy;
computer usable program code for copying each of the plurality of data packets into a buffer of the receiving interrupt queue; and
computer usable program code for interrupting a partition to notify the partition that each of the plurality of data packets is incoming.
